(19) United States
(12) Patent Application Publication
(10) Pub. No.: US 2026/0060171 A1
(43) Pub. Date: Mar. 5, 2026

(54) IDENTIFICATION OF AREAS SUITABLE FOR AUTONOMOUS MOWING

(71) Applicant: Scythe Robotics, Inc., Longmont, CO (US)

(72) Inventors: Andres Leonardo MILIOTO, Arvada, CO (US); Evan Thomas KAUFMAN, Erie, CO (US); Shawn Karl HANNA, Denver, CO (US); Kevin Eliot STONE, Westminster, CO (US); Isaac Heath ROBERTS, Lyons, CO (US); Andrew Joseph KRAMER, Seattle, WA (US); Zachary Austin GOINS, Denver, CO (US)

(21) Appl. No.: 18/818,234

(22) Filed: Aug. 28, 2024

(51) Int. Cl. A01D 34/00; A01D 101/00; G05D 1/648; G05D 105/15; G05D 107/20

(52) U.S. Cl. CPC A01D 34/008; G05D 1/6482; A01D 2101/00; G05D 2105/15; G05D 2107/23

(57) ABSTRACT

Methods and systems include receiving sensor data obtained from mowing at least one part of an area; and determining, based at least on the sensor data, whether the at least one part of the area is suitable for autonomous mowing.

### FIELD

Embodiments of the present disclosure generally relate to autonomous mowing equipment and methods of use, and more particularly, to methods and systems to aid users in judging the suitability of a property for autonomous mowing.

### BACKGROUND

Autonomous mowing of turf in commercial, industrial, residential and city park settings, among others, can save time and improve workforce efficiency for landscape maintenance contractors. Autonomous mowing has advanced to a level of technical capability where it is ready to work in those settings. Yet, like many autonomous robotic applications, the operational design domain (ODD)—which are the operational conditions for which the autonomous mower is designed and intended for use—typically has relevant limitations which the landscape contractor or robot user will want to consider.

For example, some autonomous mowing technologies are at least partially reliant on receiving GNSS (global navigation satellite system) signals from satellites for localization and navigation. The successful application of autonomous mowing to a certain property may depend on the strength or consistency of GNSS signals. At a certain property, such signals may be blocked by buildings, tree canopy, and other obstacles, making autonomous mowing less suitable or successful. Other factors will also influence the suitability of a property for autonomous mowing including the slope of the turf to be mowed, obstacles on and around the turf, turf conditions such as standing water, etc.

Accordingly, the inventors have provided embodiments of methods and systems that aid users, such as landscape maintenance contractors, in assessing the suitability of properties for autonomous mowing in planning their business operations.

### BRIEF DESCRIPTION OF THE DRAWINGS

Examples of the present disclosure, briefly summarized above and discussed in greater detail below, can be understood by reference to the illustrative examples of the disclosure depicted in the appended drawings. However, the appended drawings illustrate only typical examples of the disclosure and are therefore not to be considered limiting of scope, for the disclosure may admit to other equally effective examples.

FIG. 1 illustrates an example of an autonomous lawn mower following a coverage pattern to mow a given area in accordance with examples of the present disclosure.

FIG. 2A illustrates an example of a map of an area in accordance with examples of the present disclosure.

FIG. 2B illustrates an example of a map of an area in accordance with examples of the present disclosure.

FIG. 3 is a flow chart illustrating a method in accordance with examples of the present disclosure.

FIG. 4 is a flow chart illustrating a method in accordance with examples of the present disclosure.

FIG. 5 is a flow chart illustrating a method in accordance with examples of the present disclosure.

FIG. 6 depicts an example system in accordance with examples of the present disclosure.

To facilitate understanding, identical reference numerals have been used, where possible, to designate identical elements that are common to the figures. The Figures are not drawn to scale and may be simplified for clarity. Elements and features of one example may be beneficially incorporated in other examples without further recitation.

### DETAILED DESCRIPTION

Described in detail herein are techniques, systems, and methods for determining whether an area is suitable for successful autonomous mowing. Determining suitability for autonomous mowing could involve making a calculation or judgment that an area is or is not suitable. Determining suitability could also involve calculating a suitability score or index which could range from completely unsuitable to fully suitable and include a continuous range of suitability in between those extremes. A suitability judgment or score may, of course, involve predicting a probability of successful autonomous mowing and will involve estimations and approximations. In addition, a suitability judgment or score may apply across an entire property or area of interest, or the property may be subdivided and each subdivision can be scored or judged independently, or the suitability could be displayed graphically such as a heat map with colors, textures, shading, or symbols or gradients thereof used to indicate areas where autonomous mowing will be more or less successful.

Determining suitability for autonomous mowing could involve outputting a score or other indications to an operator or planner to aid in planning for autonomous mowing, making crew and equipment assignments, bidding a mowing job, etc. Additionally, the output of a determination of suitability could also be used by the robot to improve its function in various ways. For example, if a determination is made that a certain subpart of an area of turf is not suitable for autonomous mowing, the autonomous mower could use that information in planning its path to complete the job by avoiding areas that do not meet a threshold of suitability. Or, the autonomous robot could use that information to determine an operational plan that will be successful. For example, an autonomous mower may be capable of climbing a particular hill but only if the hill is approached from a certain angle to limit the mower's pitch or roll relative to gravity. The autonomous mower could use the suitability information to plan its mow pattern in such a way that it can successfully climb a hill. Or, using the suitability information, the mower could determine that the area of turf could be most successfully mowed if the ground speed, blade speed, mowing deck height or other operational factors are within certain bounds.

The output of a determination of suitability could also be used by the robot to estimate the amount of time or the amount of energy from a battery pack or from onboard fuel needed to mow an area, or other operational details.

Although described herein with respect to an exemplary wheeled robotic lawn mower for purposes of illustration, any of the techniques, processes, and systems described herein may be used in conjunction with mowers with track or belt drives or other types of mowers, or with mowers with configurations and designs that differ from the exemplary mower depicted in the illustrations herein, or with other agricultural and landscaping devices including, but not limited to string trimmers, edgers, and the like, as well as any other power equipment or systems for covering an area.

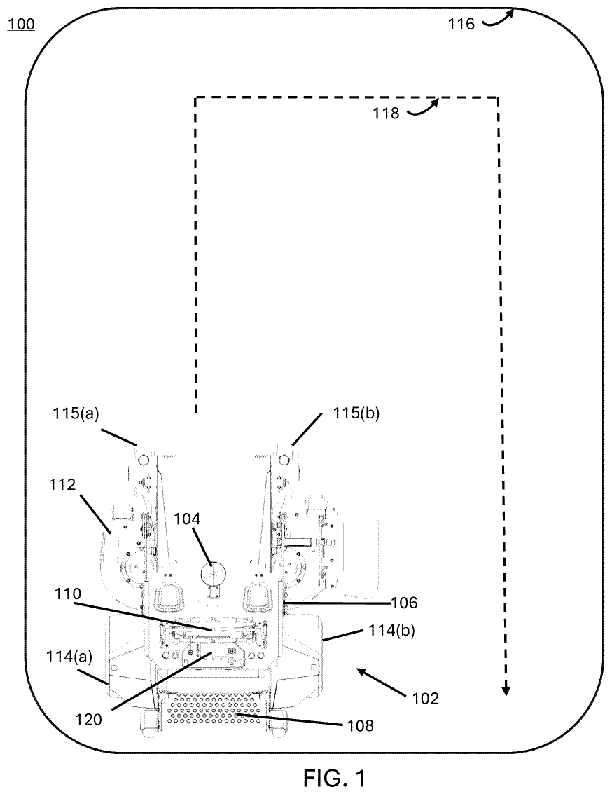

FIG. 1 illustrates an example of a system 100 for an autonomous lawn mower 102 (also referred to herein as “wheeled robot”) to follow a mow pattern to mow a given region. The autonomous lawn mower 102 may comprise one or more sensors. As illustrated in FIG. 1, autonomous lawn mower is depicted with one or more Global Navigation Satellite System(s) (GNSS) 104 sensors or antennas, image sensors 106 (which may be RGB, monochromatic, infrared, ultraviolet, etc., as well as form the basis of stereo- (as depicted) or multi-view systems), and various other sensors. The autonomous lawn mower 102 may include other forms of sensors for detecting environmental parameters and/or a state of the autonomous lawn mower 102, as will be recognized by those of skill in this art, such as, but not limited to, radar(s), lidar(s), inertial measurement unit(s) (IMU), accelerometer(s), gyroscope(s), magnetometer(s), wheel encoder(s), ultrasonic transducer(s), thermal imagers, ambient light sensor(s), time of flight sensors, barometer(s), bolometer(s), pyrometer(s), tilt sensor(s), and the like. Such sensors may be disposed about the autonomous lawn mower 102 in poses (i.e., positions and/or orientations) determined to optimize a field of view of all such sensors when combined. Image sensors 106 may comprise narrow field of view cameras and/or wide-angled cameras. Multiple image sensors 106 may be disposed about the autonomous lawn mower 102 with individual fields of view that cumulatively provide a substantially complete field of view surrounding the mower in all directions. For example, image sensors 106, or pairs of stereo image sensors may be positioned on the front of the mower 102 providing a forward field of view, on the rear of the mower 102 providing a rearward field of view, and on the left and right sides of the mower providing side fields of view. All such sensors may be calibrated to determine one or more of intrinsics or extrinsics of the sensors.

The autonomous lawn mower 102 may further comprise, as depicted in the example illustrated, one or more antennae 110. Such antennae 110 may be used for one or more of wireless network communication, cellular network communication, or any other form of electromagnetic signal transmission/reception.

The autonomous lawn mower 102 further comprises a cutting deck 112. The deck 112 provides a housing for one or more blades in order to protect nearby objects from injury, to protect damage to the blades, as well as to control how vegetation is cut and directed after cut (e.g., to be ejected as clippings from the side of the deck 112, collected in a bag, recycled and mulched within the deck, or otherwise). As is known in the art, the deck height above the immediately-surrounding traversed ground may be adjusted to control the height of cut of the grass.

As depicted, the autonomous lawn mower 102 comprises a plurality of drive wheels 114(a), 114(b). Left drive wheel 114(a) and right drive wheel 114(b) may be independently driven by one or more motors while caster wheels 115(a), 115(b) may be unpowered and freely rotate. Alternatively, drive wheels 114(a), 114(b) may be positioned in the front of mower 102 while caster wheels 115(a), 115(b) may be positioned in the rear. Or, other wheel arrangements or propulsion systems are possible, as will be recognized by those of skill in this art.

When mowing, the autonomous lawn mower 102 may be provided with a perimeter 116. The perimeter 116 may form the boundary of a given area for the autonomous lawn mower 102 to cover. As described in detail herein, a coverage planner may generate a coverage plan for the autonomous lawn mower to follow. The coverage plan may comprise a path 118 and/or series of subpaths for the autonomous lawn mower 102 to traverse. In general, the coverage planner generates a path 118 that ensures the mower (or the mower deck) traverses every part of the bounded region within the perimeter 116 so that all of the turf within perimeter 116 is mowed. The coverage planner may optimize path 118 for time to follow the path (or complete the mowing job) or other factors relating to time, energy expenditure, cut quality, etc. With a path 118, the autonomous mower 102 can autonomously navigate along the path 118 and mow within the perimeter 116 without any human intervention or operator.

In some examples, the autonomous mower 102 may be configurable to operate in a manual mode that allows manual control of the mower 102 by an operator. For manual operation by an operator, an operator platform 108 may be provided for the operator to stand on. In other embodiments, an operator seat could be provided for the operator to sit upon. Manual controls 120 provided on mower 102 will permit the operator to guide the mower over turf during mowing operations in a known manner.

To determine whether a property or are is suitable for autonomous mowing, the mower 102 may be placed into manual mode and guided by an operator while also recording or otherwise obtaining sensor data from one or more of the sensors Likewise, mower 102 could collect such sensor data while operating autonomously. Such sensor data may be stored locally on mower 102, or the sensor data may be transmitted (e.g., wirelessly) to a remote storage, such as, for example, a cloud storage. Sensor data may also be temporarily stored on mower 102 and then bulk-uploaded to a remote location at a later time when an appropriate data connection is available.

In some examples, the sensor data may include, as non-limiting examples, at least one of a location of a mower, a GNSS attribute level, camera data, perceived obstacles, presence of turf, kinematic metrics, a cell signal level, a ground plane angle, or motor or drive system parameters such as a percentage of motor torque saturation.

In some examples, the sensor data may be timestamped to correlate the sensor data with the similarly timestamped position of the mower 102, or a correlation of the sensor data to discrete locations may occur in some other way such as by directly associating position coordinates with each observation of sensor data. In some examples, the sampling rate of the sensors or the sampling rate of a data recorder connected to the sensors may vary so that some sensor data may be considered sparse data. For example, temperature and relative humidity sensors may update more slowly than a gyroscope. In some examples, a k-nearest neighbor (k-NN) algorithm may be used to classify sparse data with other denser data. In some examples, spline fitting and/or other interpolation methods may be used. In some examples, sensor data may be extrapolated to regions where the sensors are not able to operate effectively (e.g., weak signal). For example, in some examples, while the mower 102 is in motion, a GNSS attribute value may drop off below a threshold where an accurate location can be determined. In such an example, it may be possible to extrapolate the position based on prior sensor data and other sensors, such as by using visual odometry sensors (e.g., camera data). Also, in some examples, smoothing factors may be used (e.g., when GNSS attributes are lost for a period of time). Various known smoothing factors may be used.

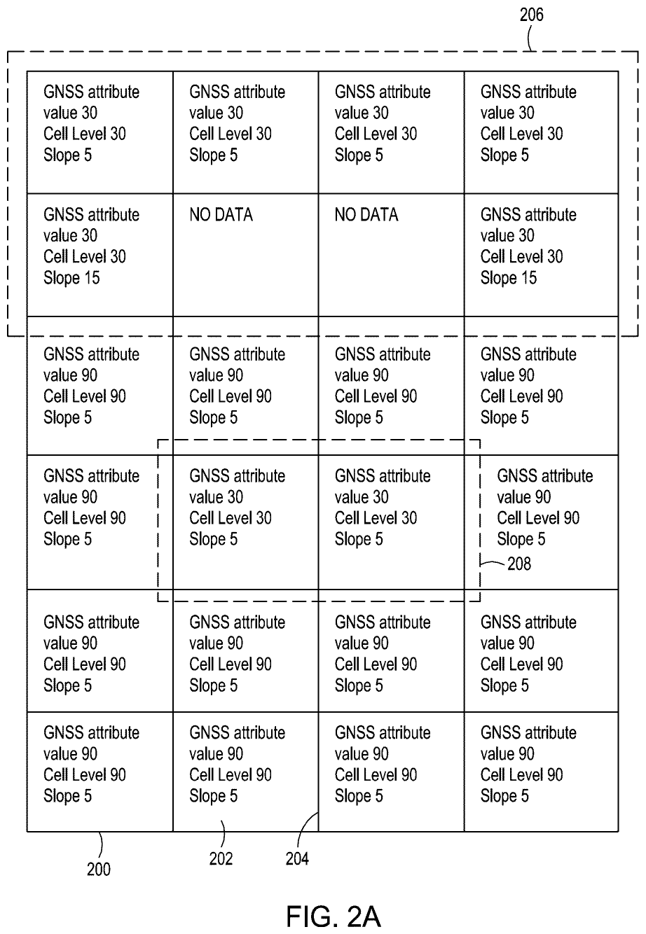

The obtained sensor data may be used to determine suitability for autonomous mowing. FIG. 2A shows a map 200 of an area 202 for which a determination of autonomous mowing suitability is desired. The area 202 is overlayed with a grid 204 marking sub-areas of the area 202. A mower, such as mower 102, may be manually controlled by an operator to mow (or traverse without mowing) at least parts of the area 202. While mowing or traversing, the location of the mower 102 within the area 202 may be determined from obtained GNSS sensor data. In some examples visual odometry may be used instead of GNSS positioning if the GNSS signal is too weak and if there are sufficient other landmarks or other velocity and acceleration data available for visual odometry. Sensor data from various sensors of mower 102 may be associated with the mower location and then may be recorded or plotted on a separate contour map or layer of the map (not shown). In some examples, the sensor data may not be discretized and may be continuous by using various data handling methods (e.g., interpolation, extrapolation, smoothing). Thus, FIG. 2A shows an example of a superposition of contour maps or map layers showing GNSS attribute value, cell signal level, and ground plane angle (i.e., slope). In at least some examples, such a map may comprise multiple layers and/or meta data associated with one or more portions. As a non-limiting example, sensor data may be used to determine one or more contours, height maps, semantic information (e.g., object type, turf type, mowable area), etc. In such examples, while one layer may indicate terrain data (e.g., a 3D map, height map, etc.), additional layers and/or meta data may be associated to indicate other data, including derived data, such as but not limited to, semantic information, environmental information, sensor signals and/or confidence levels, slope information and the like.

In some locations of the area 202 shown in FIG. 2A, sensor data is not recorded. Some regions of the area 202 may not be mowed manually due to obstacles, such as trees or shrubs, ponds, exposed roots, flower beds, building structures, etc., or because the slope of the terrain is too great to allow the mower 102 to effectively or safely be controlled manually, and thus no sensor data may be recorded for these areas. Thus, unmowed or non-traversed regions may optionally be determined to be unsuitable for autonomous mowing. In other situations, it may be desirable to extrapolate data for unmowed regions or non-traversed regions from the data for adjacent or surrounding regions in a known manner, rather than determining that such regions are per se unsuitable for autonomous mowing. In some examples, some regions that are manually mowed may be of a size where sensor data may be sparse due to sensor sampling rates, for example. In such examples, sensor data for those regions may be obtained through extrapolation or interpolation of data from nearby regions. In FIG. 2A, zones 206 and 208 are sub-areas where the sensor data results in a determination or judgment that those areas are unsuitable for autonomous mowing, or they are associated with low scores for autonomous mowing suitability. If this map information concerning suitability for autonomous mowing were given to a path planner of mower 102, such sub-areas may be considered or designated as “no-go zones” for path planning purposes, which the path planner will not consider as part of the interior of an area that must be traversed or mowed.

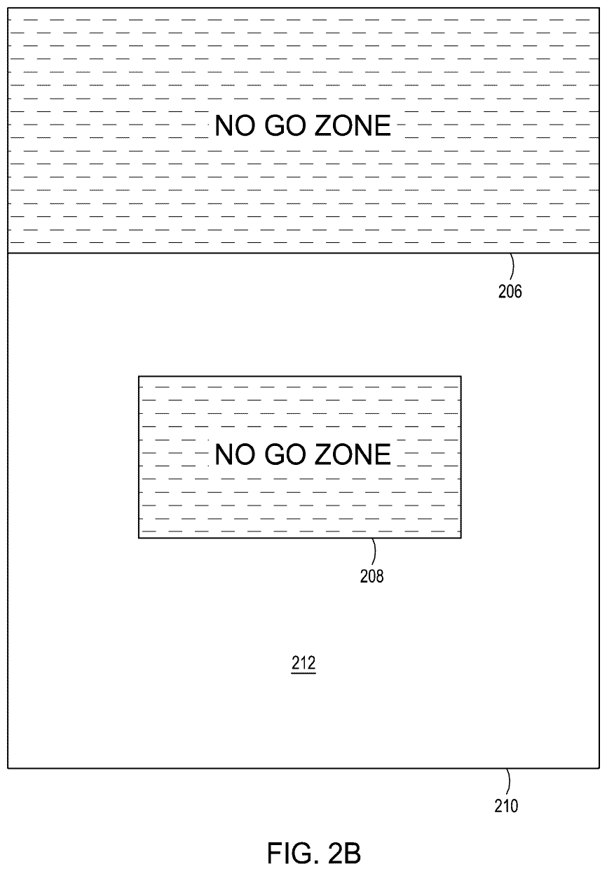

FIG. 3 shows a method 300 for identifying regions suitable for autonomous mowing, such as area 202 shown in FIG. 2A. At block 302, the method may begin with the mower 102 being controlled (e.g., manually or autonomously) and configured for recording sensor data. In some examples, an operator may set the mower into a manual or autonomous control mode and enable a mode for sensor data recording.

At block 302, the method 300 may include receiving sensor data obtained from mowing or traversing at least part of the area. For example, as the mower 102 mows parts of an area, sensor data associated with locations in the area may be obtained and recorded for processing. For example, FIG. 2A shows GNSS attribute value, cell signal level, and ground plane angle for various locations in the area 202.

As the sensor data is recorded, the mower 102 may also detect and record additional data, such as location of obstacles or ground features, found along the paths being mowed or traversed. Such obstacle data may be used later to validate no-go zones. The sensor data may also log the direction of mowing, which may be used for autonomous coverage planning. For example, if an operator manually controls the mower 102 and mows an inclined surface with a specific angle of approach or in a specific direction (such as climbing the hill head one, or climbing the hill at an angle to the slope), that direction may be recorded and used during coverage planning to create a route on the same inclined area and/or other inclined areas having similar slopes.

At block 304, the method may include identifying, based at least on the sensor data, a suitability for autonomous mowing determination or score for sub-areas, or designate certain sub-areas as suitable or unsuitable for autonomous mowing. The method may end by an operator changing the state of control of the mower 102 (e.g., from manual to autonomous or vice versa or turning the mower off). The identification at block 304 may include processing the obtained data either locally on the mower or remotely, such as in the cloud. In some examples, the sensor data may be logged and processed synchronously (i.e., in real time) or asynchronously. In some examples, obtained sensor data may be processed after some or all of the sensor data is collected, such as after an operator uploads sensor data after completing manually mowing of the area.

In some examples, during processing of the sensor data, any part or region of the area that is not initially mowed may not have corresponding sensor data and, thus, may be identified as a region that is not suitable for autonomous mowing. In some examples, identifying regions of the area that are suitable or unsuitable for autonomous mowing may be based on a heuristic model. For example, in some examples, identifying regions of the area that are suitable or unsuitable for autonomous mowing may include comparing at least some of the sensor data (or metrics derived from combinations of sensor data) to respective threshold values associated with autonomous mowing conditions, and determining whether one or more autonomous mowing conditions are satisfied. In examples, the threshold values associated with autonomous mowing conditions may represent limits for effective autonomous mowing. In some examples, the threshold values associated with various sensor data may be set automatically or by a user and may be updated over time.

In some examples, if some or all sensor data or metrics associated with successful autonomous conditions do not meet or exceed respective thresholds in a respective region of an area, then the region may be designated as unsuitable for autonomous mowing. For example, comparing the sensor data may include comparing GNSS attribute values at a respective location to threshold GNSS attribute values (e.g., 50). In some examples, if the GNSS attribute value at the location is less than the threshold GNSS attribute value (e.g., 50), then the location may be determined as not meeting the GNSS conditions for effective autonomous mowing. This is shown, for example, in zones 206 and 208 in FIG. 2A. Also, for example, comparing the sensor data may include comparing the cell signal level at a location to a threshold cell signal level (e.g., 50). In some examples, if the cell signal level at the location is less than the threshold cell signal level (e.g., 50), then the location may be determined as not meeting cell signal conditions for effective autonomous mowing. This is shown, for example, in zones 206 and 208. Also, for example, comparing the sensor data may include comparing the ground plane angle to a threshold ground plane angle (e.g., 10 degrees). In some examples, if the ground plane angle at the location is greater than the threshold ground plain angle (e.g., 10 degrees), then the location may be determined as not meeting the ground plane angle conditions for effective autonomous mowing. This is shown in zone 206 in FIG. 2A. Also, for example, comparing the sensor data may include comparing a drivetrain or drive motor parameter such as motor torque saturation to a threshold percentage.

In some examples, even if some sensor data or metrics associated with successful autonomous conditions do not meet or exceed respective thresholds (e.g., weak cell signal, GNSS attribute value), there may be some functional combination of sensor data (e.g., sensor used for odometry in some locations despite loss of GPS If there are sufficiently other landmarks) that can be used to compensate or substitute for the other sensor data (e.g., weak cell signal, GNSS attribute value), so that a determination can be made that a respective region is suitable for autonomous mowing. In some examples, the above-mentioned thresholds may be set manually or automatically and may have values based on statistics or user feedback. For example, statistical data on the effect of various sensor data parameters on autonomous mowing results (e.g., using a specific mower configuration) may be obtained over time and used to inform the thresholds for various sensor parameters.

In some examples, mowing conditions for effective autonomous mowing may be based on models of the mower 102, such as kinematic or dynamic models. For example, motor torque saturation may be a modeled parameter based on other sensor data. In some examples, if the percentage motor torque saturation at a location is greater than a threshold percentage, then the location may be determined as not meeting the motor torque saturation conditions for effective autonomous mowing.

The collected sensor data could also be stored and used in conjunction with additional data collected at a later point in time to make a determination of suitability for autonomous mowing. For example, before beginning an autonomous mowing job, additional data may be collected or obtained that can help determine an instantaneous suitability determination or score based on current conditions of the area to be mowed. Moisture data can be collected to assess the amount of water on the blades of grass in order to estimate available traction (or such moisture data can be inferred based on precipitation and other weather data the last several hours). Grass height could be measured, as another example. Such instantaneous data about site conditions could be used in conjunction with data previously collected to make a determination of autonomous mowing suitability. Instantaneous machine parameters, such as amount of energy remaining in batteries or amount of onboard fuel, could be factored into the analysis and used to determine if the autonomous mower will be capable of completing the entire mowing job. Different autonomous mowers may have different capabilities, needs, and limitations. One autonomous mower could require a GNSS signal strength for successful mowing that is different from another model. Before beginning a mowing job, the previously recorded data could be analyzed in conjunction with the requirements for a particular autonomous mower (the mower anticipated to or assigned to perform the mowing job, for example) in order to determine suitability for autonomous mowing with that mower.

In at least some examples, various combinations of the conditions may be used to determine a continuous value of suitability for autonomous mowing and such a value may be compared to a user-defined or determined threshold value to identify regions to avoid when generating a path for the autonomous mower to follow. In some examples, the continuous value of suitability for autonomous mowing may be a probability of successful autonomous mowing at a desired level (e.g., desired quality of cut, or acceptable level of risk of autonomous mowing requiring a human intervention to complete a task). In some examples, at least some of the sensor data and/or combinations thereof may be used to determine the probability of successful autonomous mowing. For example, a probabilistic contour map may be generated using the sensor data shown in FIG. 2A. In such examples, each location of the contour map may be associated with a probability of successful autonomous mowing at a desired level. In some examples, a threshold probability of successful autonomous mowing may be used to determine which regions of the heat map are at or above the threshold and which regions are below the threshold. The regions at or above the threshold may be identified as suitable for autonomous mowing and those regions below the threshold may be identified as being not suitable for autonomous mowing (i.e., no-go zones).

In addition to sensor data, in some examples, user feedback may be used as input to determining regions of an area that are suitable for autonomous mowing. For example, a user with knowledge of the area may be aware of regions that are particularly difficult to mow under manual control (e.g., the user may know there are rocks in the grass) and for which autonomous control would have a low probability of successful autonomous mowing at a desired level of cut quality. Such user may provide input that such regions of the area have a low probability of successful autonomous mowing and, therefore, that such regions should be designated as unsuitable.

In some examples, a user may assign a performance metric or score to regions of the area that were autonomously mowed. The performance metric or score can be used as an input to determine whether those regions should continue to be autonomously mowed or reclassified as no-go zones. For example, if a user observes that the mower 102 did not provide a desired quality level of cut in the region, the user may provide a performance metric or score for the region which can be compared to a threshold score for determining whether the region should be autonomously mowed or a no-go zone. An efficiency may be calculated to quantify the amount of mowing that can potentially be performed autonomously. The efficiency may be calculated as:

Efficiency=Total area determined suitable for autonomous mowing/Total area inside the perimeter of the area considered or measured.

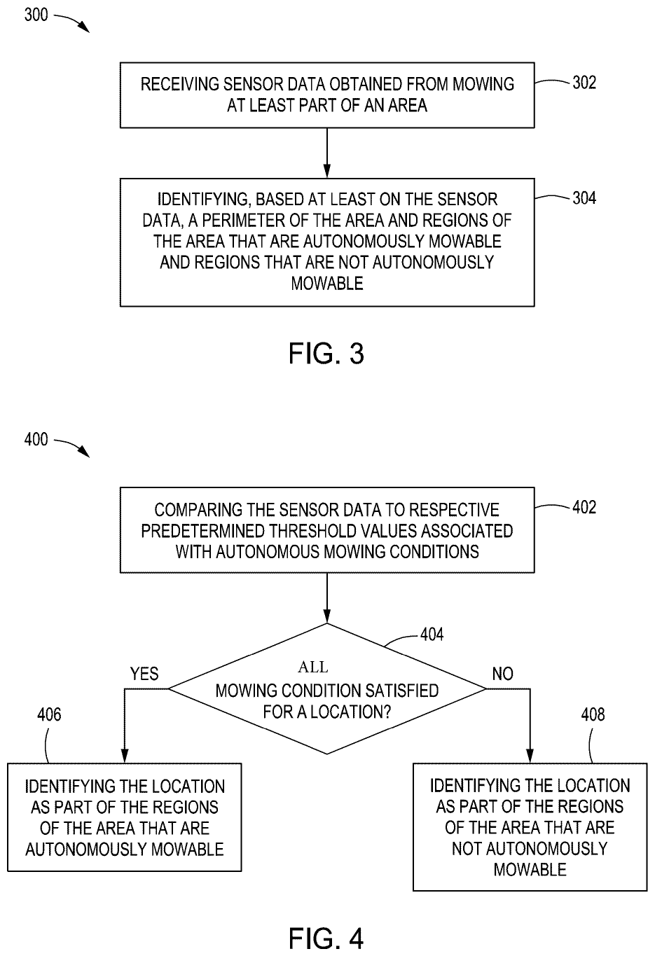

FIG. 4 shows a flow chart of an example method 400 for identifying regions of an area that are suitable for autonomous mowing and regions that are unsuitable. At block 402, the method 400 may include comparing the sensor data (or combination of sensor data) to respective predetermined threshold values associated with autonomous mowing conditions. At block 404, the method 400 may include determining whether each autonomous mowing condition (or some combination of autonomous mowing conditions) is satisfied for a respective location. If each autonomous mowing condition (or combination of mowing conditions) is satisfied for a respective location, then at block 406, the location is identified as part of the regions of the area that are suitable for autonomous mowing. However, if each autonomous mowing condition (or combination of mowing conditions) is not satisfied for a respective location, then at block 408, the location is identified as part of a region of the area that is not suitable for autonomous mowing.

In some examples, the methods 300 and 400 may be repeated n-times (where n>1) to obtain n sets of sensor data and corresponding autonomously mowable regions and no-go zones. As a non-limiting example, an area may be manually mowed “n” times prior to determining suitability for autonomous mowing. In some examples, a user may perform a manual mow of an area periodically between autonomous mowing in order to update the identification of regions that are suitable and unsuitable for autonomous mowing. By mowing “n” times, it may be possible to take into consideration changes that may occur in the mowing area over time that can affect the identification of autonomously mowable regions and no-go zones. In some examples, for the n sets of sensor data, a final autonomously mowable region may include only locations that were determined to be autonomously mowable in each of the n-sets of sensor data and all other locations may be determined to be unsuitable. In some examples, for the n sets of sensor data, a final autonomously mowable region may include only locations that were determined to be autonomously mowable in a majority or super-majority of the n-sets of sensor data and all other locations may be determined to be unsuitable. In some examples a voting scheme may be used to identify the locations that are suitable or unsuitable for autonomous mowing.

In some examples, the methods 300 and 400 may be modified so that the sensor data from the n sets may be averaged and the averaged data may then be used to identify autonomously mowable regions and no-go zones. For example, GNSS signal strength may vary from one recording session to another recording session and so the GNSS signal strength data from each recording session may be averaged and used to identify autonomously mowable regions and no-go zones.

In some examples, after making a determination of suitability for autonomous mowing, the methods 300 and 400 may be repeated, either periodically (e.g., every week) or non-periodically (e.g., based on rainfall or other weather statistics or events) to be able to update the identification of autonomously mowable regions of an area to account for changes that may occur in the mowing area over time. For example, an operator may, after any change to the area or terrain or to the capability of the autonomous mower (e.g., by hardware or software updates), manually mow the area to re-record sensor data as described above to account for any such changes. For example, a landscaper may re-record sensor data after altering the boundary of a planting bed or adding or removing a tree. Thus, the regions identified as being suitable or unsuitable for autonomous mowing can be brought up to date.

In some examples noted above, either periodically or non-periodically, an operator may review an area mowed autonomously and may provide (e.g., via an electronic interface, such as a portable computing device) a performance metric or score for one or more mowed regions of the area. The performance metric or score may be a score of the cut quality, which may be a binary score (i.e., 1=acceptable cut or 0=unacceptable cut) or a numeric grade (e.g., 0-100 with a user-defined threshold of acceptability, e.g., 50). The performance metric or score may be a factor used in the determination of suitability for autonomous mowing in methods 300 and 400, or could update such determinations by judging the success or accuracy of the prediction through actual, real-world autonomous mowing experience.

The determinations made regarding suitability for autonomous mowing may depend on the specific mower to be used for the mowing because different autonomous mowers may have different capabilities (e.g., differences in hardware configuration such as tire type, center of mass, antenna of GNSS receiver, etc.). Plotting the sensor data on maps may allow a user of an autonomous mower or a designer of an autonomous mower to identify parameters that may be responsible for a no-go designation and to adjust features of the mower or conditions of the area to increase the size of the area to be autonomously mowed. For example, if a contour map or map layer of the ground angle sensor data indicates that a certain percentage of the area is identified as a no-go zone because the ground plane angle in the no-go zones exceed a ground plane angle threshold, the user may decide to use an autonomous mower that is capable of autonomous mowing with a greater (steeper) ground plane angle to allow for an expanded autonomously mowable region of the area. Also, a designer may use the same information to inform decisions on which capabilities to add to an autonomous mower to expand autonomous mowing capabilities for users. Thus, in the foregoing example, a designer may choose to redesign a mower so that the mower that is capable of autonomous mowing with a larger ground plane angle. Also, in the case of a customer or end user, they may choose to purchase or use a mower that already is capable of autonomous mowing with a larger ground plane angle.

Determining suitability of an area for autonomous mowing could, in addition to taking into account the sensor data as described above, also include performing calculations regarding the size and shape of area. For example, a minimum threshold could be set on the size of an area that should be determined to be suitable for autonomous mowing. In addition, the shape of an area could be taken into account in making the suitability determination, with shapes that are too complex or which contain too many areas that would constitute pinch points that restrict the movement of the mower being determined to be unsuitable. Determining suitability of using the size and shape of an area could be done with heuristics and discreet values set in advance, or any type of AI model such as a neural network could be used to judge whether a size or shape is mowable, or the size and actual shape of the area could be run through the planner module to determine if a successful mowing route or plan is output from the model. In some examples, these comparisons or judgements of autonomous mowing suitability based on the size and shape of a region may generate a flag or warning for a manual review of the feasibility of the autonomously mowable regions.

Also, in some examples, a situation may occur where the regions identified as being autonomously mowable at a first time, may not be able to be mowed autonomously at a later, second time. As a result, a reconciliation process may be used to adjust the identified autonomously mowable regions and no-go zones. For example, if an obstruction is added into an identified autonomously mowable region (e.g., a tree is planted), then during autonomous mowing of the autonomously mowable region, the autonomous mower may use sensors (e.g., lidar sensors) to detect and mow around the obstruction. In some examples, a sensor data reconciliation process may take place during or after autonomous mowing to update the autonomously mowable region identified at the first time to exclude locations where obstructions were detected. In some examples, the efficiency may be recalculated and reported to a user when the autonomously mowable regions and no-go zones are updated.

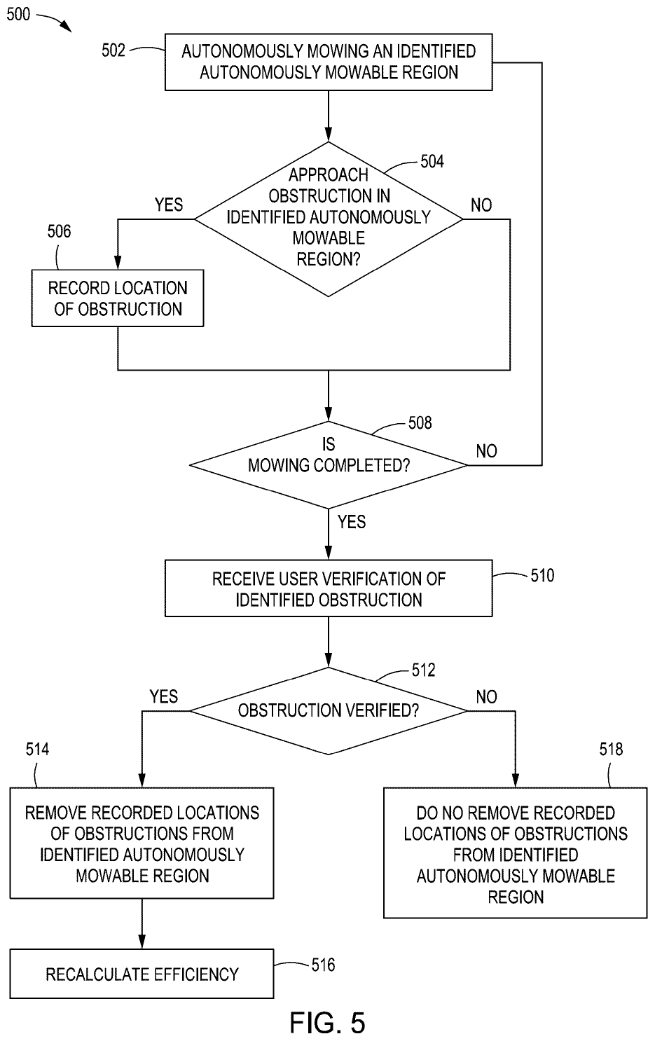

FIG. 5 shows a flow chart of an example sensor data reconciliation method 500 that may be used to continually update the identification of regions that are autonomously mowable and no-go zones. At block 502 the method 500 includes autonomously mowing a region that was identified as being autonomously mowable in accordance with example methods described herein. For example, an operator may place an autonomous mower in an autonomously mowable region and configure the mower to begin mowing in an autonomous mode. At block 504 the method 500 may include determining whether the mower has approached an obstruction in the autonomously mowable region. If YES at block 504, then the method 500 may include recording the location of the obstruction at block 506 and then continue to block 508. If NO at block 504, the method 500 may continue to block 508, wherein the method 500 may include determining whether mowing is completed. If NO at block 508, then the method 500 may return to block 502. If YES at block 508, then the method 500 may prompt a user (e.g., a landscaper) to verify any recorded obstructions. A user may receive a prompt on an electronic interface of a computing device, such as a portable computing device (e.g., smart phone or tablet computer). At block 510, the method 500 may include receiving user verification of recorded instructions. If the obstruction is verified by the user (YES at block 512), then at block 514 the method 500 may include removing recorded locations of obstructions from the identified autonomously mowable region. In some examples, after removing the recorded locations, the method 500 may include updating the efficiency calculation at block 516. If the obstruction is not verified by the user (NO at block 512), then at block 518 the recorded location of the obstruction is not removed from the identified autonomously mowable region. In some examples, in addition to a user verification, a verification may be made by a mapping service associated with the mower 102 that can receive and remotely analyze the sensor data to determine whether there is an obstruction. In some examples, if there is a discrepancy between the mapping service or the user, the user verification may override the mapping service. In some examples, the method 500 may delay prompting a user to verify any recorded obstructions until after multiple mows and detections of the obstruction.

In some examples, the method 500 may include updating (e.g., continuously or periodically) historical information about the terrain that may be sensed during repeated mowing. For example, ruts may form in turf over repeated mowing of an area, which may, over time, affect the probability of successful autonomous mowing, and which therefore may cause a region to be reclassified as a no-go zone.

In some examples, a customer may receive a map 210 such as shown in FIG. 2B that shows recommended regions suitable for autonomous mowing 212 and regions (or zones) not suitable for autonomous mowing 206 and 208. The customer may view the map 210 in a digital format, such as in a web browser or in an application. The results shared with the customer may be plotted and overlayed with satellite data. In some examples, the customer may be given the option to modify and/or approve the recommendations. For example, the customer may select and drag a perimeter of an identified autonomously mowable region or a no-go zone on the map 210 to alter a respective region or no-go zone before indicating approval. In some embodiments, the user may have an option to designate certain no-go zones as areas that may be traversed safely. One example is if the user is aware of areas in no-go zones that may be safely traversed without damage to the landscape, people, or the mower, such as an area of rocks in the grass which may be traversed if the blades are turned off. In such an example, the user may indicate an exception and a condition to turn the cutting blades off while traversing the excepted no-go zone. Upon receipt of an approval by the customer, the customer may receive a downloadable coverage plan based on the approved map. The customer may download the coverage plan to an autonomous mower (e.g., mower 102) and operate the mower in autonomous mode in the autonomously mowable region(s).

As noted herein, some autonomous mowers have sensors to detect obstacles to navigate around obstacles during autonomous control of the mower. However, obstacle detection is often limited to one vantage point which prevents the mower from rapidly learning the extent of the obstacle, leading to inefficient re-routing around the obstacle. If the obstacle is already known a priori, however, by using the methods described herein, coverage planning for the autonomously mowable regions can be done more efficiently using any of many route planning algorithms described in accordance with co-owned U.S. Pat. No. 11,579,618. As a result, an autonomous mower that has knowledge of no-go zones and mows the identified autonomously mowable regions can complete mowing of an area faster than the autonomous mower that relies solely on obstacle detection sensing.

### Example System

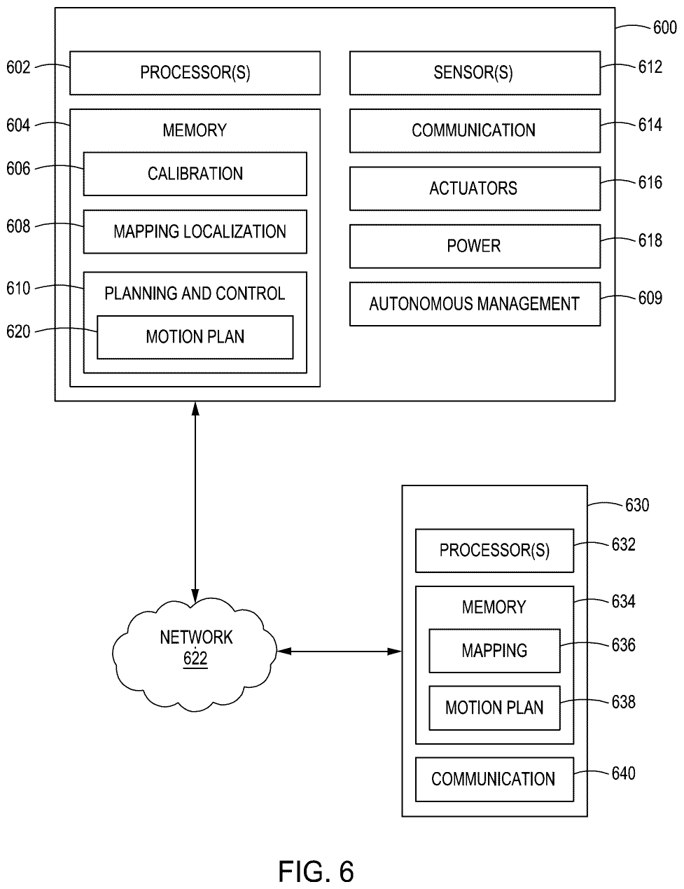

FIG. 6 is an example system 600 capable of performing the operations described herein. Such a system 600 may comprise one or more of processors 602, memory 604, sensor(s) 612, communication subsystem 614, actuators 616, and power system 618. Further, though depicted in FIG. 6 as a single system 600 for illustrative purposes, the intention is not to be so limiting. For example, the system 600 may be a distributed system (either locally or non-locally), where each block may be present on (or performed by) a remote system. Further, though particular blocks are associated with individual systems or subsystems, the description is not meant to be so limiting. Indeed, any block may be present in any one or more of the systems or subsystems illustrated in FIG. 6 (or not present at all).

The system 600 may include one or more processor(s) 602, any of which capable of performing the operations described herein. In some examples, the processor(s) 602 may be located remotely from the system 600. The one or more processor(s) 602 may comprise one or more central processing units (CPUs), one or more graphics processing units (GPUs), digital signal processors (DSPs), field programmable gate arrays (FPGAs), application specific integrated circuits (ASICs), or the like. In one example, the system 600 may include a model Jetson Xavier computing module available from Nvidia Corporation.

Memory 604 is an example of one or more non-transitory computer readable media capable of storing instructions which, when executed by any of the one or more processor(s) 602, cause the one or more processor(s) 602 to perform any one or more of the operations described herein (e.g., those described in reference to any of FIG. 1-5). The memory 604 can store an operating system and one or more software applications, instructions, programs, and/or data to implement the methods described herein and the functions attributed to the various systems. In various implementations, the memory 604 can be implemented using any suitable memory technology, such as static random access memory (SRAM), synchronous dynamic RAM (SDRAM), nonvolatile/Flash-type memory, or any other type of memory capable of storing information. The architectures, systems, and individual elements described herein can include many other logical, programmatic, and physical components, of which those shown in the accompanying figures are merely examples that are related to the discussion herein. Additionally, or alternatively, the memory 604 is capable of storing raw sensor data from the one or more sensor(s) 612, compressed or downsampled sensor data, output (or intermediate representations) of one or more machine learning models (e.g., feature maps of neural networks), and/or representations of the raw sensor data.

Sensor(s) 612 may comprise one or more image sensor(s), radar(s), lidar(s), ultrasonic(s), touch sensors, Global Positioning and/or Navigation Satellite Systems, inertial measurement units (IMUs)—which may comprise one or more accelerometers, gyroscopes, and/or magnetometers, and the like, encoders (which may be associated with any one or more wheels or one or more blades), orientation sensors, Hall sensors, ammeters, voltmeters, power meters, location systems, battery management systems, motor sensors, etc. Image sensors may comprise, for example, RGB cameras, intensity cameras (e.g., greyscale or monochrome), stereo cameras, depth cameras (e.g., structured light sensors, time of flight (TOF) cameras, etc.), RGB-D cameras, infrared cameras, ultraviolet cameras, hyperspectral cameras, and the like. In those examples where multiple image sensors are contemplated, various image sensors may have varying fields of view. For example, where at least two image sensors are used, one image sensor may be a narrow field of view camera and the other a wide-angle field of view camera.

Sensor(s) 612 may further include, for example, ultrasonic transducers (e.g., SONAR), thermal imaging sensors (e.g., infrared imagers), non-contact temperature sensors (e.g., sensors capable of determining the temperature of a surface), ambient light sensors (e.g., light sensors such as, but not limited to, photodiodes capable of determining an intensity of light at 600-1200 nm), humidity sensors, pressure sensors, bolometers, pyrometers, wind speed sensors, and the like. Sensor data from such other sensors may be used to generate three-dimensional maps and/or localize the system 600, such as in mapping/localization component 608. Any of the one or more sensor(s) 612 may also be associated with a timestamp including, but not limited to, a time of day, time of month, and/or time of year (e.g., 1-16-2018 4:50 am UTC).

Sensors(s) 612 may also comprise a deck sensor comprising at least one sensor for determining a height of the blades relative to the grass and/or the chassis (e.g., a Hall effect sensor), and/or at least one sensor for measuring blade rotation parameters such as RPM, velocity, torque sensor or the like.

Such an example system 600 as shown in FIG. 6 may additionally or alternatively comprise one or more communication subsystems 614. An example communication subsystem 614 may be used to send and receive data either over a wired or wireless communication protocol, as well as provide data connectivity between any one or more of the processor(s) 602, memory 604, and sensors 612. Such protocols may include, but are not limited to, WiFi (502.11), Bluetooth, Zigbee, Universal Serial Bus (USB), Ethernet, TCP/IP, serial communication, cellular transmission (e.g., 4G, 5G, CDMA, etc.) and the like. As indicated herein, such a communication subsystem 614 may be used to send data (e.g., sensor data, control signals, etc.) to other systems (e.g. cloud-based computers, etc.). In at least some examples, to minimize an amount of data transferred (as raw sensor data may amount to upwards of multiple gigabytes to multiple terabytes per day), raw sensor data from the one or more sensors 612 may be downsampled or compressed before transmission. In at least one example, sensor data (whether raw, compressed, downsampled, a representation thereof, or otherwise) may be automatically uploaded to another computing device when in a particular location (e.g., when in a shed, or other preselected user location). Representations of data may include, for example, averages of the data, feature maps as output from one or more neural networks, extracted features of the data, bounding boxes, segmented data, and the like.

The system 600 may comprise actuator(s) 616, such as, but not limited to, one or more motors to provide torque to one or more drive wheels (e.g., 114(a), 114(b)) associated with the system 600, a deck actuator to raise and lower a blade platform or deck (though any other actuator is contemplated), one or more motors to spin associated one or more blades for cutting, one or more brakes associated with the one or more wheels, and the like. Such actuators may further comprise, for example, electric and/or mechanical motors, hydraulics, pneumatics, and the like. Upon receiving a signal from one or more of the planning and control subsystem 610, at least a portion of the actuator(s) may actuate in order to effectuate a trajectory (steering, acceleration, etc.), release fertilizer, seed, herbicide, pesticide, insecticide, seed, etc., and the like.

In one example, the drive motors may be one or more brushless DC motors, permanent magnet AC motors, AC induction motors, switched reluctance motors or the like. The motor controller circuits (power switching) may be separate from the motors or built into the motors. In one example, the motor controllers may operate on the Field Oriented Control (FOC) principle, a technique that allows a brushless motor to operate at very high efficiency. The motor controllers may use a three-phase half-H inverter design utilizing N-channel MOSFETs (e.g., SiC FETs or IGBTs). The motor controllers may utilize rotor feedback to facilitate accurate FOC motor control via encoders (e.g., inductive, optical, magnetic, or conductive), resolvers, Hall effect sensors, or “sensorless” through back EMF measurements from the motors themselves.

The actuator(s) for spinning the blades may be, for example, a brushless DC motor rotating the blades at, for example, about 1000 RPM up to about 5000 RPM when operating nominally. The deck actuator may comprise one or more linear actuator such as solenoid(s), ball screw(s), rack and pinion assembly(ies), hydraulic/pneumatic piston, or the like.

The actuator(s) 616 may further comprise a brake system. Such a brake system may be electronically controlled to perform braking and/or a brake assembly may be coupled to each motor to slow the rotation of each wheel independent, when braking is used to steer the mower, or slow rotation of both drive wheels 114(a), 114(b) simultaneously, when front wheel steering is used to steer the mower. In one example, the control subsystem 610 may use a friction-based braking system with friction pads (either disk, drum, or clutch style brakes) that are coupled to a motor shaft, either before or after a transmission or other gearing that may form part of each motor. The braking system may be electromagnetically actuated via a solenoid, linear actuator or other electric-motor driven mechanism. Using such a braking system enables the mower to be held at zero velocity when the mower is not being commanded to move. In addition, a friction based braking system saves power and prevents runaway mowers in the event of emergency stops or system failure. In addition to, or in lieu of, the friction braking system, the control subsystem 610 may utilize regenerative braking through control of the drive motors. In one example, regenerative braking is used for non-emergency braking during normal operation and friction braking is used during emergency stops and parking. With regenerative braking, energy from mower inertia is either transferred into the battery(ies) and/or into a brake resistor.

System 600 may also comprise a power system 618 including, but not limited to one or more of batteries, battery packs, fuel cells, super capacitors, or otherwise to provide power to the one or more processor(s) 602, actuators 616, sensor(s) 612, or any other component or subcomponent of the system 600 which requires power. The power system 618 may be removable such that the power system 618 can be removed and replaced when not operating within norms, e.g., recharge capacity is below a capacity threshold. The power system 618 may include multiple energy sources such as a battery or fuel cell for powering the mower electronics and a tank for gasoline, natural gas, hydrogen, or other fuel for powering one or more motors.

Though not illustrated for clarity, the system 600 may comprise one or more support circuits which may comprise circuits and devices that support the functionality of the processor(s) 602. The support circuits may comprise, one or more or any combination of: clock circuits, communications circuits, cache memory, power supplies, interface circuits for the various sensors, actuators, and communications circuits, and the like. More specifically, the support circuits may comprise sensor interfaces, communication circuit(s) interfaces, and actuator drive interfaces. The sensor interfaces may support data transfer from the sensor(s) 612 to the processor(s) 602 through one or more, or any combination of, data buffering/caching, signal digitizing, signal amplification, digital and/or analog signal processing, filtering, limiting, and/or the like.

The communication circuits interfaces may support data transfer to/from the communications circuits (e.g., LTE and/or WiFi transceivers) to/from the processor(s) 602 through one or more, or any combination of, digital and/or analog signal processing, filtering, limiting, amplifying, and/or the like. The communications circuits may comprise one or more communications transceivers (modems) and their associated antennas. In some examples, the communication circuits may include, but are not limited to, a pair of WiFi transceivers, a pair of LTE transceivers, or the like. The antennas generally may include a plurality of antennas to ensure diverse antenna positioning on the mower body to combat multi-path interference. A pair of transceivers may be used to provide redundancy. For example, two antennas for each transceiver (eight antennas total) may be mounted on either side of the body 102(a). The antennas for LTE/WiFi and GNSS may be collocated in a single antenna housing (dome).

The actuator drive interfaces may support control of the actuators 616 (e.g., drive motors, brake system, blade motors, deck actuator, etc.) through one or more, or any combination of, current, voltage or pulse width modulated signal controllers in the form of motor controllers, brake controllers, solenoid controllers and/or the like.

Within memory 604, a calibration component 606 may perform calibration of the one or more sensor(s) 612 and/or actuators 616. Calibration may comprise determining one or more sensor intrinsics and/or extrinsics, as well as determining positions of components or subcomponents (e.g., blade height), applied torques relative to currents applied, and the like. Such calibration protocols performed by calibration component 606 may ensure that any one or more components or subcomponents of system 600 is working properly and enable correct calculations to be generated given the system's 600 current understanding of the relative positions, orientations, and parameters of the other components and subcomponents.

A mapping/localization component 608 may take in sensor data from any one or more of the sensor(s) 612, in addition to any one or more outputs from the calibration component 606 to one or more of map an area and/or provide a position and/or orientation of the system 600 relative to the map. In at least one example, sensor data from the one or more sensor(s) 612 may be used to construct (and/or update) a two- and/or three-dimensional map of the scanned area. When updating, preexisting map data may be received from memory 604 and/or from server 630. Multiple mapping techniques may be used to construct a two- or three-dimensional map based on the acquired sensor data including, but not limited to SLAM, Kalman filters (Unscented Kalman Filters, Extended Kalman Filters, etc.), occupancy grids, bundle adjustment, sliding window filters, and the like. Such a map may be stored as a signed distance function (SDF), or truncated SDF (TSDF), triangle mesh, mosaics, etc. Use of voxel hashing may improve memory requirements for both storage and raycasting. In at least some examples, sensor data may include radar data indicative of subterranean objects (e.g., pipes, golf balls, rocks, etc.). Such subterranean objects may provide features for use in creating the map. For example, locations of sprinklers, piping, rocks, moisture levels, and the like may be combined (or fused) with other sensor data to both generate the maps and localize against them.

Furthermore, various combinations of sensor data may be used to provide additional insight as derived sensor data. As a non-limiting example, sensor data from wide-angle, dual baseline, image sensors may be used to reconstruct depth of the environment and provide additional features for use in generating the map and or localizing the system 600 against such a map. Any such derived sensor data may be either used for mapping and/or localization, as well as may be associated with the map after it has been generated (e.g., storing the value associated with the portion of the map where the data was collected). Further, in at least some examples, control signals (as may be received and/or generated by system 600) may be associated with the map at mapping and localization component 608. In some examples, GNSS data may be used to inform a Region of Interest (ROI) of satellite imagery to download to, or otherwise augment, the two-or three-dimensional map. Additionally, or alternatively, such a system 600 may download, or otherwise access, weather data as additional sensor data. The weather data may be indicative of, for example, weather conditions for the time of day associated with the other sensor data.

Such maps may comprise signed distance functions (SDFs) or truncated signed distance functions TSDFs, mesh representations, UTM grids, mosaics, tiles, etc., including any topological relationship between such sensor data. In some examples, voxel hashing may be used to minimize memory requirements for both map storage and retrieval. Such a map may also be associated with additional sensor data (and/or data derived from the additional sensor data, such as segmentations, classifications, output from machine learning algorithms, etc.). For example, moisture level data, soil density data, vegetative health indicators (growth, absence of growth, presence of pests, presence of weeds or invasive species, etc.), thermal data, ambient light data, etc. may be associated with every location in the three-dimensional map. Additionally, or alternatively, image sensor data (e.g., color) may be associated with the map as well (e.g., by weighted averaging, or the like), so that a user viewing the map would quickly see a virtual representation of the scanned area, including color.

An autonomous management component 609 may receive sensor data obtained from manually mowing at least part of an area and identify, based at least on the sensor data, a perimeter of the area and regions of the area that are autonomously mowable and regions that are not autonomously mowable. The autonomously mowable regions may be used by the mapping component 608 and the planning and control component 610 to generate maps and coverage plans for routing a mower within the identified autonomously mowable regions.

The planning and control subsystem 610 may determine commands for operating one or more of the actuator(s) 616. In some examples, such a planning and control subsystem 610 may determine one or more trajectories for the system 600 to follow (e.g., by determining a series of steering commands, acceleration commands, etc. which cause the system 600 to follow an intended pattern). Such trajectories may be determined in accordance with waypoints (e.g., GNSS-based waypoints) as may be received from a user via control interface (not shown) and/or calculated to optimize (e.g., minimize) a length of travel over a defined region of interest (e.g., as may be determined by server 630), a quality of cut, or a time to mow an area, for example. In various examples, one or more of the waypoints and/or trajectories may be based at least in part on a motion plan received from one or more of motion planner 620 or motion planner 638.

Motion planners 620 and 638 may determine the trajectories and control torques to drive wheels of the system 600 in accordance with the methods of motion planning described herein. Thus, in examples, the motion planners 620 and 638 may receive path information and waypoints for movement of the system 600 and determine a set of control torques for the first and second drive wheels to control the system 600 to move between a first point of the pair and a second point of the pair. The motion planners 620 and 638 may determine how to apply the set of control torques to the first and second drive wheels to move the system 600 along the path.

In any such example provided herein, such trajectories and/or controls may be calculated iteratively (and/or periodically) such that the system 600 (and/or associated user(s)) always has the most relevant information.

Multiple examples have been given to illustrate various features and are not intended to be so limiting. Any one or more of the features may not be limited to the particular examples presented herein, regardless of any order, combination, or connections described. In fact, it should be understood that any combination of the features and/or elements described by way of example above are contemplated, including any variation or modification which is not enumerated, but capable of achieving the same. Unless otherwise stated, any one or more of the features may be combined in any order.

As above, figures are presented herein for illustrative purposes and are not meant to impose any structural limitations, unless otherwise specified. Various modifications to any of the structures shown in the figures are contemplated to be within the scope of the systems, techniques, and processes presented herein. Such systems, techniques, processes, etc. are not intended to be limited to any scope of claim language.

Where “coupling” or “connection” is used, unless otherwise specified, no limitation is implied that the coupling or connection be restricted to a physical coupling or connection and, instead, should be read to include communicative couplings, including wireless transmissions and protocols.

Any block, step, module, or otherwise described herein may represent one or more instructions which can be stored on a non-transitory computer readable media as software and/or performed by hardware. Any such block, module, step, or otherwise can be performed by various software and/or hardware combinations in a manner which may be automated, including the use of specialized hardware designed to achieve such a purpose. As above, any number of blocks, steps, or modules may be performed in any order or not at all, including substantially simultaneously, i.e., within tolerances of the systems executing the block, step, or module.

Where conditional language is used, including, but not limited to, “can,” “could,” “may” or “might,” it should be understood that the associated features or elements are not required. As such, where conditional language is used, the elements and/or features should be understood as being optionally present in at least some examples, and not necessarily conditioned upon anything, unless otherwise specified.

Where lists are enumerated in the alternative or conjunctive (e.g. one or more of A, B, and/or C), unless stated otherwise, it is understood to include one or more of each element, including any one or more combinations of any number of the enumerated elements (e.g., A, AB, AB, ABC, ABB, etc.). When “and/or” is used, it should be understood that the elements may be joined in the alternative or conjunctive.

### Example Clauses

A. A method comprising:
receiving sensor data obtained from mowing at least one part of an area; and
determining, based at least on the sensor data, whether the at least one part of the area is suitable for autonomous mowing.

B. The method of clause A, wherein determining whether the at least one part of the area is suitable for autonomous mowing includes calculating a suitability score based at least on the sensor data and comparing the suitability score to a threshold suitability score.

C. The method of clause A or B, wherein calculating the suitability score includes calculating a probability of successful autonomous mowing to a certain level.

D. The method of any of clauses A-C, wherein the suitability score is calculated based at least upon the sensor data including at least one of location of a mower, GNSS attributes, cell signal level, camera data, perceived obstacles, presence of turf, kinematic metrics, or ground plane angle.

E. The method of any of clauses A-D, further comprising designating subareas within the area that are suitable and unsuitable for autonomous mowing based at least in part on the determining whether the at least one part of the area is suitable for autonomous mowing.

F. The method of any of clauses A-E, further comprising generating a coverage plan for autonomously mowing the of the subareas that designated as being suitable for autonomous mowing.

G. The method of any of clauses A-F, wherein: determining whether the at least one part of the area is suitable for autonomous mowing includes:
comparing the sensor data to respective threshold values associated with one or more autonomous mowing conditions; and
determining whether one or more autonomous mowing conditions are satisfied.

### H. a System Comprising:

one or more processors; and
one or more non-transitory computer readable media storing instructions thereon which, when executed by the one or more processors, cause the one or more processors to perform operations comprising:
receiving sensor data obtained from mowing at least one part of an area; and
determining, based at least on the sensor data, whether the at least one part of the area is suitable for autonomous mowing.

I. The system of clause H, wherein determining whether the at least one part of the area is suitable for autonomous mowing includes calculating a suitability score based at least on the sensor data and comparing the suitability score to a threshold suitability score.

J. The system of clause H or I, wherein calculating the suitability score includes calculating a probability of successful autonomous mowing to a certain level.

K. The system of any of clauses H-J, wherein the suitability score is calculated based at least upon the sensor data including at least one of location of a mower, GNSS attributes, cell signal level, camera data, perceived obstacles, presence of turf, kinematic metrics, or ground plane angle.

L. The system of any of clauses H-K, further comprising designating subareas within the area that are suitable and unsuitable for autonomous mowing based at least in part on the determining whether the at least one part of the area is suitable for autonomous mowing.

M. The system of any of clauses H-L, further comprising generating a coverage plan for autonomously mowing the of the subareas that designated as being suitable for autonomous mowing.

N. The system of any of clauses H-M, wherein: determining whether the at least one part of the area is suitable for autonomous mowing includes:
comparing the sensor data to respective threshold values associated with one or more autonomous mowing conditions; and
determining whether one or more autonomous mowing conditions are satisfied.

O. One or more non-transitory computer readable media having instructions stored thereon which, when executed by one or more processors, cause the one or more processors to perform a method comprising:
receiving sensor data obtained from mowing at least one part of an area; and
determining, based at least on the sensor data, whether the at least one part of the area is suitable for autonomous mowing.

P. The non-transitory computer readable media of clause O, wherein determining whether the at least one part of the area is suitable for autonomous mowing includes calculating a suitability score based at least on the sensor data and comparing the suitability score to a threshold suitability score.

Q. The non-transitory computer readable media of clause O or P, wherein calculating the suitability score includes calculating a probability of successful autonomous mowing to a certain level.

R. The non-transitory computer readable media of any of clauses O-Q, further comprising designating subareas within the area that are suitable and unsuitable for autonomous mowing based at least in part on the determining whether the at least one part of the area is suitable for autonomous mowing.

S. The non-transitory computer readable media of any of clauses O-R, further comprising generating a coverage plan for autonomously mowing the of the subareas that designated as being suitable for autonomous mowing.

T. The non-transitory computer readable media of any of clauses O-S, wherein determining whether the at least one part of the area is suitable for autonomous mowing includes:
comparing the sensor data to respective threshold values associated with one or more autonomous mowing conditions; and
determining whether one or more autonomous mowing conditions are satisfied.

1. A method comprising:
receiving sensor data obtained from mowing at least one part of an area; and
determining, based at least on the sensor data, whether the at least one part of the area is suitable for autonomous mowing.

2. The method of claim 1, wherein determining whether the at least one part of the area is suitable for autonomous mowing includes calculating a suitability score based at least on the sensor data and comparing the suitability score to a threshold suitability score.

3. The method of claim 2, wherein calculating the suitability score includes calculating a probability of successful autonomous mowing to a certain level.

4. The method of claim 2, wherein the suitability score is calculated based at least upon the sensor data including at least one of location of a mower, GNSS attributes, cell signal level, camera data, perceived obstacles, presence of turf, kinematic metrics, or ground plane angle.

5. The method of claim 1, further comprising designating subareas within the area that are suitable and unsuitable for autonomous mowing based at least in part on the determining whether the at least one part of the area is suitable for autonomous mowing.

6. The method of claim 5, further comprising generating a coverage plan for autonomously mowing the of the subareas that designated as being suitable for autonomous mowing.

7. The method of claim 1, wherein: determining whether the at least one part of the area is suitable for autonomous mowing includes:
comparing the sensor data to respective threshold values associated with one or more autonomous mowing conditions; and
determining whether one or more autonomous mowing conditions are satisfied.

8. A system comprising:
one or more processors; and
one or more non-transitory computer readable media storing instructions thereon which, when executed by the one or more processors, cause the one or more processors to perform operations comprising:
receiving sensor data obtained from mowing at least one part of an area; and
determining, based at least on the sensor data, whether the at least one part of the area is suitable for autonomous mowing.

9. The system of claim 8, wherein determining whether the at least one part of the area is suitable for autonomous mowing includes calculating a suitability score based at least on the sensor data and comparing the suitability score to a threshold suitability score.

10. The system of claim 9, wherein calculating the suitability score includes calculating a probability of successful autonomous mowing to a certain level.

11. The system of claim 9, wherein the suitability score is calculated based at least upon the sensor data including at least one of location of a mower, GNSS attributes, cell signal level, camera data, perceived obstacles, presence of turf, kinematic metrics, or ground plane angle.

12. The system of claim 8, further comprising designating subareas within the area that are suitable and unsuitable for autonomous mowing based at least in part on the determining whether the at least one part of the area is suitable for autonomous mowing.

13. The system of claim 12, further comprising generating a coverage plan for autonomously mowing the of the subareas that designated as being suitable for autonomous mowing.

14. The system of claim 8, wherein: determining whether the at least one part of the area is suitable for autonomous mowing includes:
comparing the sensor data to respective threshold values associated with one or more autonomous mowing conditions; and
determining whether one or more autonomous mowing conditions are satisfied.

15. One or more non-transitory computer readable media having instructions stored thereon which, when executed by one or more processors, cause the one or more processors to perform a method comprising:
receiving sensor data obtained from mowing at least one part of an area; and
determining, based at least on the sensor data, whether the at least one part of the area is suitable for autonomous mowing.

16. The non-transitory computer readable media of claim 15, wherein determining whether the at least one part of the area is suitable for autonomous mowing includes calculating a suitability score based at least on the sensor data and comparing the suitability score to a threshold suitability score.

17. The non-transitory computer readable media of claim 16, wherein calculating the suitability score includes calculating a probability of successful autonomous mowing to a certain level.

18. The non-transitory computer readable media of claim 15, further comprising designating subareas within the area that are suitable and unsuitable for autonomous mowing based at least in part on the determining whether the at least one part of the area is suitable for autonomous mowing.

19. The non-transitory computer readable media of claim 18, further comprising generating a coverage plan for autonomously mowing the of the subareas that designated as being suitable for autonomous mowing.

20. The non-transitory computer readable media of claim 15, wherein determining whether the at least one part of the area is suitable for autonomous mowing includes:
comparing the sensor data to respective threshold values associated with one or more autonomous mowing conditions; and
determining whether one or more autonomous mowing conditions are satisfied.
